(19) United States
(12) Patent Application Publication
(10) Pub. No.: US 2026/0086259 A1
(43) Pub. Date: Mar. 26, 2026

(54) DEVICE AND METHOD FOR GROUND SURVEYING

(71) Applicant: DEEP SCAN TECH OY, Espoo (FI)

(72) Inventors: Juhani KORKEALAAKSO, Espoo (FI); Antti KNUUTI, Espoo (FI)

(21) Appl. No.: 19/109,140

(22) PCT Filed: Sep. 11, 2023
(86) PCT No.: PCT/FI2023/050516

§ 371 Date: Mar. 6, 2025

(30) Foreign Application Priority Data
Sep. 9, 2022 (FI) 20225786

(51) Int. Cl. G01V 3/02

(52) U.S. Cl. CPC G01V 3/02

(57) ABSTRACT

A rod (200) for ground surveying comprises an elongate shaft (201) and a head (202) formed by or attached to the first end of the shaft (201), for easing the penetration of the rod (200) into ground or for generating a particular effect when force is applied to the rod. The rod comprises a plurality of ground current electrodes (203) located at intervals along at least a part of the length of the shaft (201), and ground current connections (204) between said ground current electrodes (203) and respective connection points (205). Said connection points (205) are located either within the rod (200) closer to the second end of the shaft (201) than any of said plurality of ground current electrodes (203) or beyond the second end of the shaft (201).

### FIELD OF THE INVENTION

The invention concerns generally the technical field of ground surveying. In particular, the invention concerns the determining of electrical conductivity and related quantities within a three-dimensional target volume of ground.

### BACKGROUND OF THE INVENTION

As a general term, ground surveying covers all methods and practices that are used to obtain qualitative and/or quantitative information about underground conditions within a certain target volume of ground. Most common examples are ground surveys made in preparation of new construction projects in order to examine, what preconditions the ground characteristics set to the constructing task. A non-exhaustive list of other applications of ground surveying includes for example examining the condition of earthen dams; evaluating the need for additional draining around or under existing buildings; estimating the effect of spills from landfills and other potential sources of pollution; locating and assessing the condition of underground structures such as pipes, cables, and foundations; and the like.

A special case of ground surveying is constituted by measurements of electrical conductivity. Two basic examples are shown in FIG. 1. On the left, two electrodes 101 and 102 have been placed on the ground surface and a potential difference has been created between them. The potential difference gives rise to a distribution of electric currents through various parts of the ground. If the electric conductivity of the ground was even, equipotential surfaces would have the regular form shown by the dashed lines, of which lines 103 and 104 are shown as examples. Electric currents go perpendicularly through the equipotential surfaces, as schematically illustrated by the solid lines like 105 and 106. On the right in FIG. 1, two electrodes 111 and 112 have been placed under ground, in drilled holes for example. Again, a potential difference between the electrodes 111 and 112 gives rise to equipotential surfaces and a distribution of electric currents through the ground.

In practical target volumes of ground, electrical conductivity is not even but varies depending on a variety of factors such as soil type and composition, moisture content, and the like. By making measurements like those in FIG. 1 between a plurality of measurement points and using the measured results as inputs to inversion calculations, it is possible to find an estimate of the most probable three-dimensional distribution of electrical conductivity within the examined volume of ground that would make such measurement results to occur. While pure electrical conductivity as such may be of limited value as information, it may be used to deduce related quantities like moisture content, soil type, and occurrence of large rocks, animal burrows, constructed structures underground, and the like.

The technical difficulty of measurements like those on the left in FIG. 1 is the relatively shallow depth in ground from which accurate results can be obtained. Measurements like those on the right in FIG. 1 give more accurate information also concerning deeper layers of ground, but getting a sufficiently large number of electrodes deep enough into the ground is laborious and time-consuming.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

It is an objective to provide means and methods for generating more accurate information about ground characteristics within a target volume of ground, while simultaneously respecting constraints related to cost, complexity, and applicability to various types of ground and various application areas.

According to a first aspect, there is provided a rod for ground surveying. The rod comprises an elongate shaft with a first end and a second end, and a head formed by or attached to the first end of the shaft, for easing the penetration of the rod into ground under application of force from the direction of the second end of the shaft or for generating a particular effect when force is applied to the rod once it has penetrated into ground. The rod comprises a plurality of ground current electrodes located at intervals along at least a part of the length of the shaft and ground current connections between said ground current electrodes and respective connection points. Said connection points are located either within the rod closer to the second end of the shaft than any of said plurality of ground current electrodes or beyond the second end of the shaft.

According to an embodiment, said ground current electrodes are fixedly attached to the shaft. This involves at least the advantages that the structure is simple and robust.

According to an embodiment, each of said ground current electrodes comprises an exposed contact surface on an outside of the shaft. This involves at least the advantage that good and reliable conductive connection can be established between each of said ground current electrodes and the soil in its immediate surroundings.

According to an embodiment, each of said ground current electrodes comprises an outer contact surface part that forms said exposed contact surface, an insulator layer between said outer contact surface part and the outside of the shaft, said insulator layer attaching said outer contact surface part to the shaft, and an electrical connection through said insulator layer and a wall of the shaft, for connecting said outer contact surface part to a respective ground current connection inside the shaft. This involves at least the advantage that the structure is relatively simple to manufacture, robust in use, and possible to make such that it does not have unwanted directionality.

According to an embodiment, said ground current electrodes are releasably coupled to the shaft. This involves at least the advantage that the shaft can be retrieved while leaving the ground current electrodes in place in the ground.

According to an embodiment, the shaft is tubular. At least some of the ground current electrodes may then be located inside the tubular shaft, and said tubular shaft may be configured to slide off in its longitudinal direction, for exposing said at least part of the ground current electrodes. This involves at least the advantage that the ground current electrodes are safe from mechanical wear or damage while the rod is driven into ground, yet fully operational when the tubular shaft has been removed.

According to an embodiment, the rod comprises a releasable joint between said shaft and said head. This involves at least the advantage that the head may be left into ground if desired, when the shaft is retrieved.

According to an embodiment, said head is one of said ground current electrodes or houses at least one of said ground current electrodes. This involves at least the advantage that the lowest electrode give information from at least as deep in the ground as the head reaches.

According to an embodiment, said head is a standardised head for ground surveying rods or augers. This involves at least the advantage that the same rod can be used for standard-compliant mechanical ground surveying.

According to a second aspect, there is provided an arrangement for ground surveying. The arrangement comprises at least two rods of the kind described above, and a measurement device configured to feed measurement currents to and measure received currents from said ground current electrodes.

According to a third aspect, there is provided a method for ground surveying. The method comprises
sinking at least two rods of the kind described above into ground within a target volume of ground,
feeding measurement currents to at least a first portion of the ground current electrodes comprised in said at least two rods,
measuring received currents from at least a second portion of the ground current electrodes comprised in said at least two rods, and
generating a three-dimensional model of ground characteristics in at least a part of said target volume of ground based on calculations from said measurement currents and received currents.

### BRIEF DESCRIPTION OF THE DRAWINGS

In the drawings:

FIG. 1 illustrates two examples of prior art measurements,

FIG. 2 illustrates a rod,

FIG. 3 illustrates a section of a rod,

FIG. 4 illustrates a section of a rod,

FIG. 5 illustrates a rod and some of its structural details,

FIG. 6 illustrates a structural detail of a rod,

FIG. 7 illustrates a structural detail of a rod, and

FIG. 8 illustrates an arrangement.

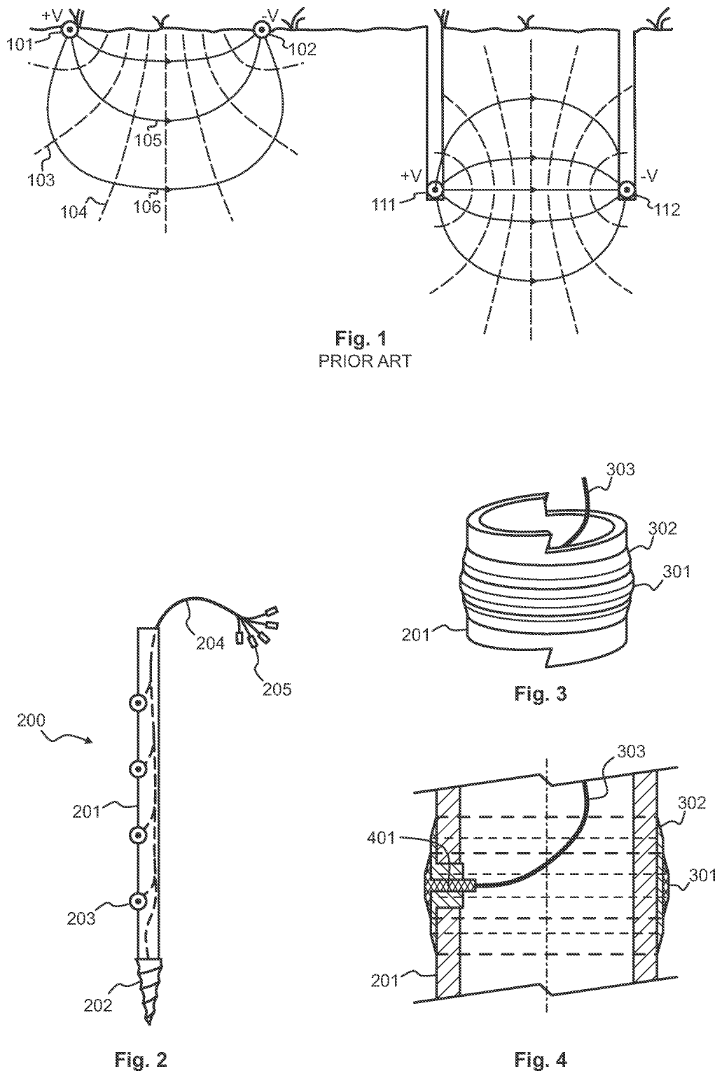

### DETAILED DESCRIPTION

In the following description, reference is made to the accompanying drawings, which form part of the disclosure, and in which are shown, by way of illustration, specific aspects in which the present disclosure may be placed. It is understood that other aspects may be utilised, and structural or logical changes may be made without departing from the scope of the present disclosure. The following detailed description, therefore, is not to be taken in a limiting sense, as the scope of the present disclosure is defined be the appended claims.

For instance, it is understood that a disclosure in connection with a described method may also hold true for a corresponding device or system configured to perform the method and vice versa. For example, if a specific method step is described, a corresponding device may include a unit to perform the described method step, even if such unit is not explicitly described or illustrated in the figures. On the other hand, for example, if a specific apparatus is described based on functional units, a corresponding method may include a step performing the described functionality, even if such step is not explicitly described or illustrated in the figures. Further, it is understood that the features of the various example aspects described herein may be combined with each other, unless specifically noted otherwise.

An aspect related to the present invention is that a large number of ground surveys are done, and will be done also in the future, with traditional mechanical methods that involve repeatedly driving a so-called ground surveying rod to a certain depth into the ground, at an extensive number of grid points that cover the target volume of ground. A non-limiting exemplary list of traditional mechanical method includes cone penetration (CPT; Cone Penetration Test), standard penetration, dynamic probing, weight sounding, and field vane testing. In many cases, a ground survey of this kind is mandatory under the local regulations that govern building and construction activities. Consequently, there are well-established practices and even standards related to the equipment used and the methods executed. An example of such a standard is a head standard, which defines a standardised head for ground surveying rods, also referred to sometimes as ground surveying augers. Such a standard is needed to ensure that the conclusions made from the way in which the ground surveying rod penetrates the soil are commensurable between different measurements.

An important finding is that the equipment provided for the purposes of such previously known mechanical ground surveying methods may be augmented to serve also measurements of electric conductivity between a matrix of measurement points that cover the whole target area. Here, and also in the continuation below, electric conductivity means particularly, but not necessarily exclusively, complex electrical conductivity. Instead of, or in addition to, electrical conductivity one may consider (complex) electrical resistivity, which is essentially an inverse of electrical conductivity.

Integrating measurement means for electrical conductivity with equipment suitable for mechanical ground surveying has at least three important, advantageous consequences. First, it eliminates the need for manufacturing and handling separate mechanical means for the purpose of taking such measurement means deep enough into the ground: the measurement means may “hitch a ride” within the equipment suitable for mechanical ground surveying. Second, it offers a possibility to make the measurements of electrical conductivity dynamically as a function of depth: one may perform measurements of electrical conductivity also already while the rod is still in the process of penetrating into the ground. This enables making the measurements of electrical conductivity at an essentially stepless range of depths, if desired. Third, it allows combining the results from the measurements of electrical conductivity with the results of the mechanical ground survey, allowing bi-directionally interlinked interpretation of the results.

There are also some further advantages that can be gained in at least some cases. In mechanical ground surveying, it is not uncommon that the rod hits a rock or other obstacle before reaching the intended depth. Obviously, in such a case the mechanical method does not give any information of anything deeper than that. A measurement of electrical conductivity may, however, give information about larger depths at that location, because the electric currents flow in three dimensions and propagate also through layers of ground deeper than the lowest measurement electrode, the effect of which may then become tangible and conceivable in the processed measurement results. As an example, a measurement of electrical conductivity may be used to ascertain that the underground obstacle in question is indeed the solid bedrock and not only some erratic boulder.

Yet another advantage is the additional accuracy and possibility to avoid interpretation errors, when compared to purely mechanical ground surveying. The person executing a mechanical ground survey makes their observations and interpretations along the way, as the rod proceeds penetrating into the ground. If something went unobserved or misinterpreted, like some more delicate change in ground characteristics, there is usually no way the mechanical ground survey could back up and return to examining that characteristic. To the contrary, as the measurement of electrical conductivity takes place in three dimensions, it can also “look back” or follow the penetrating head at some distance, giving information about layers of ground that the head has already passed.

FIG. 2 illustrates schematically a rod 200 for ground surveying. The schematic representation in FIG. 2 does not take any position concerning the detailed mechanical structure of parts of the rod; examples of such detailed mechanical structures will be given later in this text. The rod 200 comprises an elongate shaft 201 with a first end and a second end. For the purpose of illustration, the first end of the shaft 201 is its lower end and the second end of the shaft 201 is its upper end in FIG. 2.

The rod 200 comprises a head 202, which is formed by or attached to the first end of the shaft 201. The purpose of the head 202 may be to ease the penetration of the rod 200 into ground under application of force from the direction of the second end (upper end in FIG. 2) of the shaft 201. Said force may involve any or both of a linear component, driving the rod 200 into the direction to which the head 202 points, and a rotating component, rotating the rod around its longitudinal axis. Additionally or alternatively, the purpose of the head 202 may be to generate a particular effect when force is applied to the rod once it has penetrated into ground. An example of such a head is the vane head used in field vane testing.

The shape and material of the head 202 should be selected with said purpose in mind. For example, the head 202 may be made of a hard, firm material such as an alloy of iron. It may have a sharp point and/or a screw-like spiral pattern of grooves and ridges covering its sides. If the intended purpose is related to field vane testing, the head 202 may have the corresponding characteristic paddle wheel form. According to an advantageous embodiment, the head 202 is a standardised head for ground surveying rods or augers.

All in all, the material, dimensions, and other properties of the shaft 201 and the head 202 have been selected so that the rod 200 is as such directly applicable of performing mechanical ground surveys of the kind described earlier in this text. Alternative designations for the rod 200 include, but are not limited to, a ground surveying auger, a drill rod, a (ground surveying) probe, and a sound.

As a difference to conventional rods used for mechanical ground surveys, the rod 200 comprises a plurality of ground current electrodes located at intervals along at least a part of the length of the shaft 201. Electrode 203 is shown as an example in FIG. 2, so the reference designator 203 may be used to refer to one or more of the plurality of ground current electrodes. An electrode as meant here is a point or area of limited dimensions provided for making an electrically conductive connection. Examples of electrodes are given later in this text.

Additionally, the rod 200 comprises ground current connections 204 between the ground current electrodes 203 and respective connection points. Connection point 205 is shown as an example in FIG. 2, so the reference designator 205 may be used to refer to one or more of the connection points. The connection points 205 and ground current connections 204 are there for facilitating the making of electrically conductive connections to and from the ground current electrodes 203 even when that part of the length of the rod 200 along which the ground current electrodes are located has penetrated into the ground or is otherwise not directly accessible. For this purpose, the connection points 205 may be located within the rod 200, closer to the second end of the shaft 201 than any of the plurality of ground current electrodes. Additionally or alternatively, the connection points may be located beyond the second end of the shaft 201, for example at the distant end(s) of one or more cables that extend from the rod 200.

According to an embodiment, the ground current electrodes 203 are fixedly attached to the shaft 201. The outer surface of the shaft 201 may have holes or recesses to house such fixedly attached ground current electrodes. Alternatively, each ground current electrode 203 may comprise an exposed contact surface on an outside of the shaft 201.

FIGS. 3 and 4 illustrate an example of a ground current electrode of the latter kind. Both FIG. 3 and FIG. 4 show schematically a cut-out portion of the length of the shaft 201. FIG. 3 shows said cut-out portion in an axonometric view and FIG. 4 shows it in a schematic cross-section. The ground current electrode according to this embodiment comprises an outer contact surface part 301 that forms the exposed contact surface. An insulator layer 302 is located between the outer contact surface part 301 and the outside of the shaft 201. The insulator layer 302 mechanically attaches the outer contact surface part 301 to the shaft 201 and simultaneously insulates it electrically from the shaft 201.

In FIGS. 3 and 4 both the insulator layer 302 and the outer contact surface part 301 are ring-shaped and encircle the cylindrical outer surface of the shaft 201. This is not essential, as many other shapes could be used. It is, however, advantageous to a certain extent if the shape of the outer contact surface part is such that electrical conductivity is not directionally restrictive in the radial direction. In other words, it may be advantageous to use a shape of the outer contact surface part 301 that does not make the electrical connection to the surrounding medium dependent on the rotational position of the rod around its longitudinal axis.

An electrical connection 401 is provided through the insulator layer 302 and the wall of the shaft 201, for connecting the outer contact surface part 301 to a respective ground current connection 303 inside the shaft 201. Basically, it would be possible to route the ground current connection 303 also outside the shaft 201, either as a loose cable or as a conductive wire or strip mechanically supported by but electrically insulated from the shaft 201. However, taken that the rod is to be driven into ground, the ground current connection 303 is better protected against wear and damage if it runs inside the shaft 201.

Instead of being fixedly attached to the shaft 201, the ground current electrodes 203 may be releasably coupled to the shaft 201. Such an arrangement may have at least two purposes, which do not exclude each other. First, if the rod 200 is meant to be used also for purely mechanical ground surveys when needed, it may be advisable to remove the ground current electrodes 203 at those times so that they do not come into way and are certain to not be worn or damaged in vain when not needed. Second, it may be possible to drive the rod 200 into ground with the ground current electrodes 203 in place and then remove either the whole rod 200 or at least the shaft 201, leaving the ground current electrodes 203 buried in the ground so that they can be used to measure electrical conductivity (also) later.

One way in which the principle of releasably coupled ground current electrodes may be realised is such where the shaft is tubular, at least some of the ground current electrodes are located inside the tubular shaft, and said tubular shaft is configured to slide off in its longitudinal direction, for exposing said at least part of the ground current electrodes.

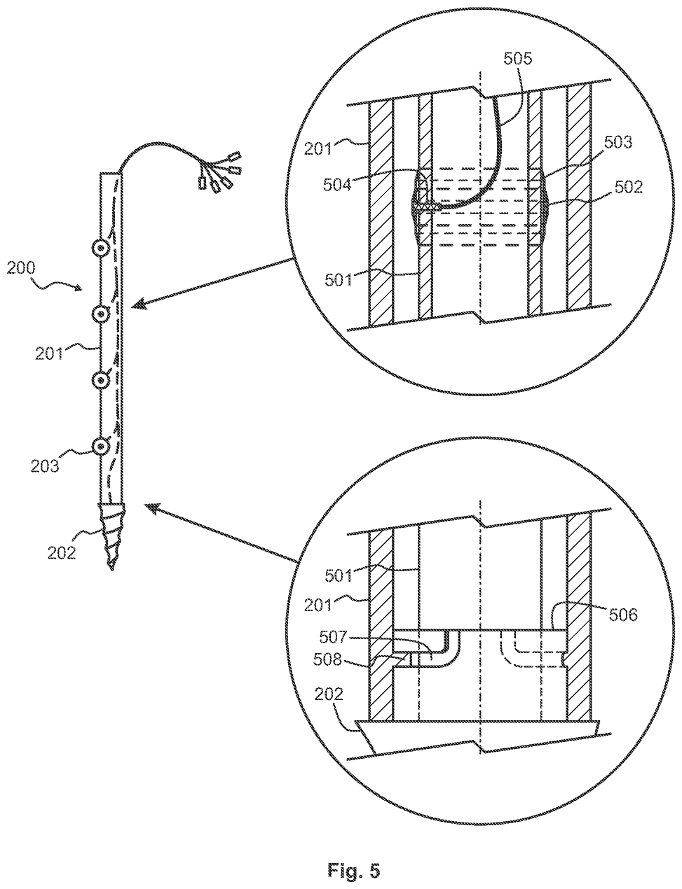

FIG. 5 illustrates a rod 200 according to an embodiment in which the ground current electrodes are releasably coupled to the shaft 201. As shown in the upper partial enlargement, the shaft 201 is tubular and at least some of the ground current electrodes are located inside the tubular shaft 201. In this embodiment, there is a separate mechanical support structure, namely an inner tube 501, concentrically located inside the shaft 201. Such a separate mechanical support structure does not need to be tubular or concentric with shaft 201, as other alternatives are possible.

The ground current electrode shown in the upper partial enlargement of FIG. 5 has a structure generally similar to that shown earlier in FIGS. 3 and 4, only supported by the inner tube 501 and not by the shaft 201. In other words, the ground current electrode in the upper partial enlargement in FIG. 5 comprises an outer contact surface part 502 that forms an exposed contact surface and an insulator layer 503 between said outer contact surface part 503 and the outside of the inner tube 501. Said insulator layer 503 attaches the outer contact surface part 502 to the inner tube 501 and electrically insulates it therefrom. An electrical connection 504 is provided through said insulator layer 503 and the wall of the inner tube 501, for connecting the outer contact surface part 502 to a respective ground current connection 505 inside the inner tube 501.

The lower partial enlargement in FIG. 5 shows a detail that could also used in other embodiments, for example in such embodiments where the ground current electrodes along the length of the shaft are fixedly attached to the shaft. Concerning the graphical representation, the lower partial enlargement in FIG. 5 is a partial cross-section so that the shaft 201 is shown in cross section while the head 202 and the inner tube 501 are not.

As shown in the lower partial enlargement in FIG. 5, the rod may comprise a releasable joint between the shaft 201 and the head 202. The exemplary embodiment shown here is a bayonet-type releasable joint. The head 202 comprises an upwards extending stem 506, the outer diameter of which matches relatively closely the inner diameter of the tubular shaft 201. Consequently, the stem 506 of the head 202 may be slid inside the first end of the tubular shaft 201. Grooves 507 in the stem 506 are configured to receive pins 508 that protrude from the inner surface of the shaft 201. Rotating the shaft 201 in one direction makes each pin 508 reach and engage with the blind end of the respective groove 507, so that continuing to rotate the shaft 201 in that direction will make the head 202 rotate along. Rotating the shaft 201 in the opposite direction makes each pin 508 come out of the respective groove 507, releasing the shaft 201 from the head 202.

The mechanism shown in the lower partial enlargement in FIG. 5 is naturally just an example. A person skilled in the art of releasable mechanical joints between solid pieces may present a plurality of alternative ways of implementing a releasable coupling between the shaft 201 and the head 202. As one intended use of the releasable coupling is to allow retrieving the shaft while leaving the head buried in the ground, it is advisable to construct the releasable coupling if used—so that it can be released without having direct access to the head.

According to an embodiment, the head 202 may be one of the ground current electrodes 203. Alternatively or additionally, the head 202 may house at least one of the ground current electrodes 203. This possibility has been accounted for in FIGS. 2 and 5 by schematically showing one of the ground current connections coming from the head 202.

Using the head 202 as one of the ground current electrodes (and/or using a ground current electrode housed in the head) involves certain advantages. The head 202 may be made of a material such as an alloy of iron that is inherently a relatively good electrical conductor, which means that no further structures or components (other than the respective ground current connection) may be needed to use it as a ground current electrode. Also, due to its location at the lower extreme of the rod 200, the head 202 will penetrate deepest into the ground, establishing a good measurement point when it is considered that the purpose is anyway to take the measurement points into the ground and not only on (or very close to) the ground surface as in many measurement schemes of previously known kind. In those embodiments that involve a releasable coupling between the shaft and the head, said advantages may be carried on to the period of time well after the initial ground survey, because the head may remain in place, buried in the ground, for a very long time. Some standardised ground surveying methods even require using a fresh head each time, so making the head a single-use item for the purpose described above would not even significantly add to the consumption of material resources.

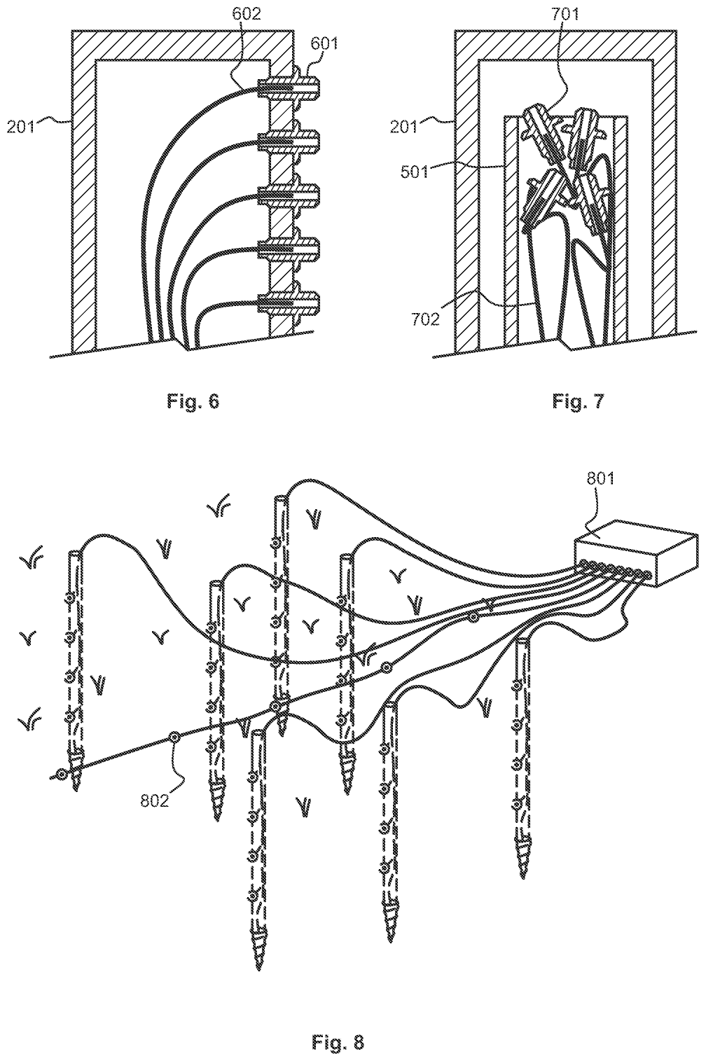

FIGS. 6 and 7 illustrate schematically some possibilities for implementing the connection points from which there are the ground current connections to the respective ground current electrodes. In the embodiment shown in FIG. 6, the second end of the shaft 201 comprises one or more electrical connectors 601, from which there are ground current connections 602 to the respective ground current electrodes further down the shaft 201 (not shown in FIG. 6). FIG. 7 shows an embodiment in which there is an inner tube 501 inside the tubular shaft 201, and one or more connectors 701 at the ends of ground current connections 702 are temporarily stored inside the inner tube 501. In this embodiment, once the shaft 201 has been released and removed, one may pick the connector(s) 701 out of the inner tube 501 for use. The principles shown schematically in FIGS. 6 and 7 may be mixed in many ways: for example, it is possible to have connector(s) temporarily inside like in FIG. 7 even if there is no other structural part than the shaft, so that one would pick out the connector(s) from inside the shaft once the rod has been driven into ground as desired. In such a case, the second end of the shaft may comprise an openable hatch or just an opening. As a further example, one may have fixed connectors like those in FIG. 6 but fixed to an additional support structure inside the (releasable and removable) shaft; for example fixed to the upper end of an inner tube 501 like in FIG. 7.

As a yet another possibility, the connection points may be well beyond the second end of the shaft already to begin with. An example of that is an embodiment in which the ground current connections come out of an opening at or close to the second end of the shaft and continue therefrom for a significant distance before ending in connectors or the like, or just in bare cable heads to which suitable connectors can be attached when needed.

FIG. 8 shows schematically an arrangement for ground surveying according to an embodiment. As the purpose is to measure electrical conductivity in a three-dimensional matrix between measurement points, the arrangement comprises at least two rods of the kind described above. In the embodiment shown in FIG. 8, there are eight rods, all of which have been driven into the ground deep enough so that even the topmost ground current electrode (that closest to the second end of the shaft) is under the ground surface. The arrangement comprises a measurement device 801 configured to feed measurement currents to, and measure received currents from, the ground current electrodes in the rods.

It is possible, although not necessary, to also have ground surface electrodes in the arrangement. In FIG. 8, there is schematically shown one measurement cable on the ground, with five ground surface electrodes at known positions along its length. Ground surface electrode 802 is shown as an example. In this example, most of the ground surface electrodes are within the surface area generally delimited by the outermost rods. Additionally or alternatively, at least some ground surface electrodes may be placed outside said surface area. That involves the additional advantage that information may be gathered from a larger volume of ground that extends further than the outermost rods.

In this embodiment, the measurement device 801 is locally present and the ground current connections extend, possibly via extension cables, to connectors in the measurement device 801. Other embodiments are possible, for example so that there is a current transceiver integrated with each rod for feeding measurement currents to, and for measuring received currents from, the ground current electrodes in that rod. Such current transceivers may be further coupled, in a wired and/or wireless manner, to a central processing unit that may collect the measurement results and perform the calculations that eventually give the three-dimensional conductivity model of the target volume of ground. In yet another alternative embodiment, the current transceiver may be common to some or all of the rods used within a particular target volume of ground, but such a common current transceiver may then send its collected measurement data to a separate central processing unit.

Method embodiments of the invention may be characterised as comprising certain method steps, such as
sinking at least two rods of the kind described above into ground within a target volume of ground,
feeding measurement currents to at least a first portion of the ground current electrodes comprised in said rods,
measuring received currents from at least a second portion of the ground current electrodes comprised in said rods, and
generating a three-dimensional model of ground characteristics in at least a part of said target volume of ground based on calculations from said measurement currents and received currents.

The method may involve repeated rounds through the steps of feeding measurement currents, measuring received currents, and generating the three-dimensional model. Such repeated rounds may take place over even very long periods of time, such as several years for example, if the purpose is to monitor the long-term development in the ground characteristics of interest.

An example of a measurement current that may be used in the method is a low-frequency alternating current. A low frequency means here a frequency lower than 5 Hz, and preferably lower than 1 Hz. For example, the arrangement may feed a current of constant absolute amplitude between two measurement electrodes and switch the polarity of the current at intervals of about two seconds. This will create a potential field in the measurement volume.

After each switching of the input polarity, the measured current increases first rapidly and then forms a round knee, eventually saturating on some constant level. The constant level, if reached, gives an indication of the DC conductivity (or resistivity) on the measured distance. Frequency-dependent components of (complex) conductivity (or complex resistivity) give the form to said round knee in the measured current. If the current pulses are short, the measured current does not have the time to reach the constant (DC) level, in which case one observes only the frequency-dependent components and uses them in the calculation. Such short pulses of current may be used as measurement current of higher frequency, typically up to 100 Hz.

The measurements and calculations may aim at detecting the full-wave form of the created potential field, being essentially indicative of resistance as a function of frequency. Inversion calculations from the measurement results may then reveal the desired three-dimensional complex resistance (or complex conductivity) distribution or various responses to the so-called induced polarisation.

The inversion calculation typically involves simulating the examined volume of ground with an element model, in which the continuous mass of ground is represented with a three-dimensional matrix of elementary volume units. These elementary volume units may have for example the form of tetrahedrons, each defined by a selected set of four ground current electrodes. The technique of how a measurement current is fed through such selected set of ground current electrodes and how the relation between the current fed and potential difference measured is utilised in the inversion calculations is known as such for the person skilled in the art.

The inversion calculation may utilise prior information of the examined volume of ground in setting up an initial model, from which the calculation then proceeds in an iterative manner towards a calculated model that provides the best obtainable match with the measurement results. For example, if the mechanical ground survey-on the rods of which the ground current electrodes “hitched a ride” into the ground-showed that there is a solid surface of bedrock at a certain depth, one may set the bedrock surface as a constant boundary condition for the inversion calculation. The same applies to all kinds of known features within (or close to) the examined volume of ground. In an advantageous embodiment, there may be a plurality of known, precisely located characteristics across the examined volume of ground, so that the inversion calculations only need to fill in the spaces of previously unknown conductivity between the known points.

As a general method of inversion calculation, one may use for example the iterative Newton-Raphson method. The measurement results are represented with a large system of equations, in which the conductivity values within the elementary volume units constitute the unknowns. The best-matching solution of the system of equations (in the root mean squares sense) is essentially found through an iterative series of matrix inversion operations that may be computationally quite intensive, as the matrices involved are large and the required amounts of random access memory are consequently quite extensive.

Most advantageously, measurements of the kind described above are linked to soil drillings, in order to collect information on the ground stratification and to obtain geotechnical parameters or direct input for design methods. Field tests may give results about geology/stratification of the ground; type of structure, the possible foundation, and the anticipated work during the construction; type of geotechnical parameter required; design method to be adopted in the planned construction, and so on.

The method may involve using the calculationally generated three-dimensional model of ground characteristics as feedback to further actions in the associated mechanical ground survey. For example, one may decide, based on the knowledge obtained so far, where to sink a further rod into the ground to obtain further results either mechanically or electrically or both.

Any range or device value given herein may be extended or altered without losing the effect sought. Also any embodiment may be combined with another embodiment unless explicitly disallowed.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims and other equivalent features and acts are intended to be within the scope of the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item may refer to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the embodiments described above may be combined with aspects of any of the other embodiments described to form further embodiments without losing the effect sought.

The term ‘comprising’ is used herein to mean including the method, blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A rod for ground surveying, comprising:
an elongate shaft with a first end and a second end and
a head formed by or attached to the first end of the shaft, for easing the penetration of the rod into ground under application of force from the direction of the second end of the shaft or for generating a particular effect when force is applied to the rod once it has penetrated into ground
a plurality of ground current electrodes located at intervals along at least a part of the length of the shaft, and
ground current connections between said ground current electrodes and respective connection points;
wherein:
said connection points are located either within the rod closer to the second end of the shaft than any of said plurality of ground current electrodes or beyond the second end of the shaft,
said ground current electrodes are releasably coupled to the shaft,
the shaft is tubular,
at least some of the ground current electrodes are located inside the tubular shaft, and
said tubular shaft is configured to slide off in its longitudinal direction, for exposing said at least part of the ground current electrodes.

2. (canceled)

3. (canceled)

4. (canceled)

5. (canceled)

6. (canceled)

7. A rod according to 1, comprising a releasable joint between said shaft and said head.

8. A rod according to claim 1, wherein said head is one of said ground current electrodes or houses at least one of said ground current electrodes.

9. A rod according to claim 1, wherein said head is a standardised head for ground surveying rods or augers.

10. An arrangement for ground surveying, comprising:
at least two rods and
a measurement device configured to feed measurement currents to and measure received currents from said ground current electrodes;
wherein each of said at least two rods comprises:
an elongate shaft with a first end and a second end and
a bead formed by or attached to the first end of the shaft, for easing the penetration of the rod into ground under application of force from the direction of the second end of the shaft or for generating a particular effect when force is applied to the rod once it has penetrated into ground,
a plurality of ground current electrodes located at intervals along at least a part of the length of the shaft, and
ground current connections between said ground current electrodes and and wherein:
said connection points are located either within the rod closer to the second end of the shaft than any of said plurality of ground current electrode or beyond the second end of the shaft,
said ground current electrodes are releasably coupled to the shaft,
the shaft is tubular,
at least some of the ground current electrodes are located inside the tubular shaft, and
said tubular shaft is configured to slide off in its longitudinal direction, for exposing said at least part of the ground current electrodes.

11. A method for ground surveying, comprising:
sinking at least two rods into ground within a target volume of ground,
feeding measurement currents to at least a first portion of the ground current electrodes comprised in said at least two rods,
measuring received currents from at least a second portion of the ground current electrodes comprised in said at least two rods, and
generating a three-dimensional model of ground characteristics in at least a part of said target volume of ground based on calculations from said measurement currents and received currents, wherein each of said at least two rods comprises,
an elongate shaft with a first end and a second end and
a head formed by or attached to the first end of the shaft, for easing the penetration of the rod into ground under application of force from the direction of the second end of the shaft or for generating a particular effect when force is applied to the rod once it has penetrated into ground,
a plurality of ground current electrodes located at intervals along at least a part of the length of the shaft, and
ground current connections between said ground current electrodes and respective connection points;
and wherein,
said connection points are located either within the rod closer to the second end of the shaft than any of said plurality of ground current electrodes or beyond the second end of the shaft,
said ground current electrodes are releasably coupled to the shaft,
the shaft is tubular,
least some of the ground current electrodes are locate inside the tubular shaft, and
said tubular shaft is configured o slide off in its longitudinal direction, for exposing said at least part of the ground current electrodes.
